(19) United States
(12) Patent Application Publication
(10) Pub. No.: US 2004/0235425 A1
(43) Pub. Date: Nov. 25, 2004

(54) Mobile link power control method

(76) Inventors: Daniel R. Tayloe, Phoenix, AZ (US); Mark T. Pflum, Chandler, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/441,695

(22) Filed: May 20, 2003

(51) Int. Cl. H04B 1/00; H04B 7/00; H04Q 7/20

(52) U.S. Cl. 455/69; 455/522

(57) ABSTRACT

A power control method (50) is applicable either to a base station 20 or a mobile station (1-N). This method takes into account the previous two power control bits (52-54). The method then determines a correction factor by multiplying the power control step size by the sum of the previous two power control bits (56). A corrected received signal is produced (58) and compared to a threshold signal (62). Based on this comparison, power control is set up (64) for data frames below the signal threshold or power is set down (66) for data frames equal to or above the signal threshold.

### BACKGROUND OF THE INVENTION

The present invention pertains to power control in a mobile telecommunication system and more particularly to power control of the links between the base station and the mobile station.

Mobile telecommunication systems include wireless links between mobile stations, which may be mobile telephones, pagers, computers, etc., and the base station of the mobile telecommunication system. Since these links are wireless, the links are susceptible to noise and interference with other signals. The signals received at the mobile station may “fade”. That is, the data signals received by the mobile station may become much more attenuated than the surrounding noise and other interference.

The quality of wireless telecommunications is often measured by the ability of the mobile stations to receive accurate and clear data. As fading of a signal is detected, the base station of the mobile telecommunication system may increase the transmission power it is using to reach the mobile station. Further, if the received data signal is not subject to fading the base station may decrease the power with which the data is transmitted to the mobile station.

When greater power is used on a particular wireless link, this increase in power creates interference for the other links connecting other mobile stations to the base station.

In a co-demand multiple access (CDMA) mobile telecommunication system, power control bits are continuously sent, approximately every 1.25 milliseconds, requesting that the entity on the other end of the link to power up by one step or power down by one step. That is, each mobile station continuously sends power control bits (PCB) to the base station, requesting that the base station transmit with greater power since the data signal is fading. However, there is a minimum of a delay time of two power control bits between the time the mobile station requests and the base station can respond. This two power bit delay time causes the power observed by the mobile to oscillate, nominally 5 dB peak to peak for a minus one dB power step size. This oscillation wastes transmit power of the base station and battery power for the mobile station. In addition, the oscillation creates interference for other mobile stations and links within the telecommunication system and further decreases the system capacity.

Accordingly, it would be highly desirable to have a power control method which inhibits power transmission oscillation and increases battery life of a mobile station.

### BRIEF DESCRIPTION OF THE DRAWING

FIG. 1 is a block diagram of a mobile telecommunication system in accordance with the present invention.

FIG. 2 is a flow chart of a power control method in accordance with the present invention.

FIG. 3 is a diagram of power control without the present invention.

FIG. 4 is a diagram of power control with the present invention.

### DESCRIPTION OF THE PREFERRED EMBODIMENT OF THE INVENTION

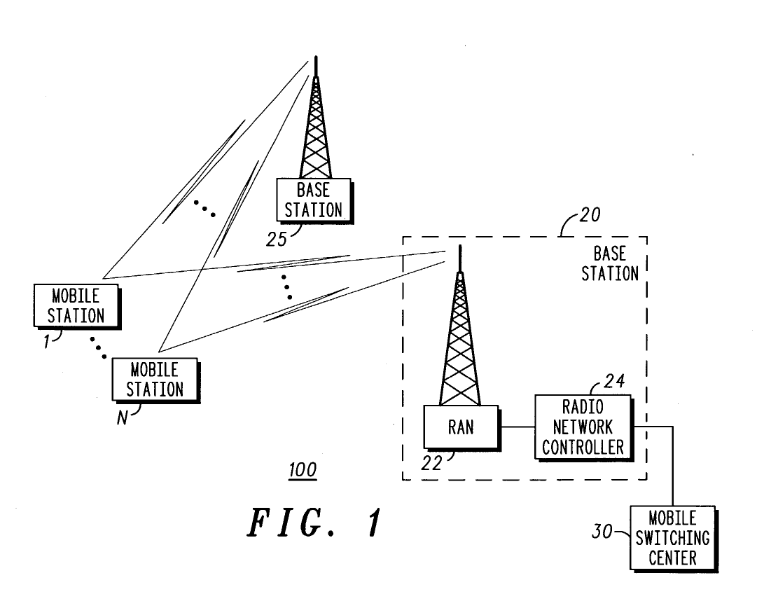

FIG. 1 is a block diagram depicting a mobile telecommunication system 100. Mobile telecommunication system 100 includes mobile network equipment 20, 25 and 30 and mobile stations 1-N. The mobile network equipment or communication infrastructure includes base stations 20 and 25 and mobile switching center 30, for example. A typical base station 20 includes a radio access network (RAN) 22 and a radio network controller (RNC) 24. Radio network controller 24 is coupled to a mobile switching center 30.

Each mobile station 1-N is coupled to RAN 22 of base station 20 via a mobile link. These mobile links include a forward channel which is the base station 20 transmitting to the mobile station 1, for example, and a reverse channel which is the mobile station 1 transmitting to base station 20.

One or more base stations 25 may also provide wireless data links coupling mobile stations 1-N in order to provide for constant communication by transmitting the same data to the mobile stations.

The base stations 20-25 control the power with which the mobile stations 1-N send data on the reverse link. Similarly, mobile stations 1-N control the power of signals transmitted by base stations 20, 25 for data transmitted on the forward link.

The power used by mobile stations 1-N is of critical importance since this power is typically supplied by batteries. Transmit power is controlled on both the forward and reverse channels. That is, the base station controls the power which the mobile station transmits data to the base station and the mobile station controls the power which the base station transmits data to the mobile station. The following power control method will be explained for the base station controlling the power used by the mobile station to transmit; however, it is noted that the power control method may also be employed within the mobile station for controlling the power transmitted by the base station on the forward link.

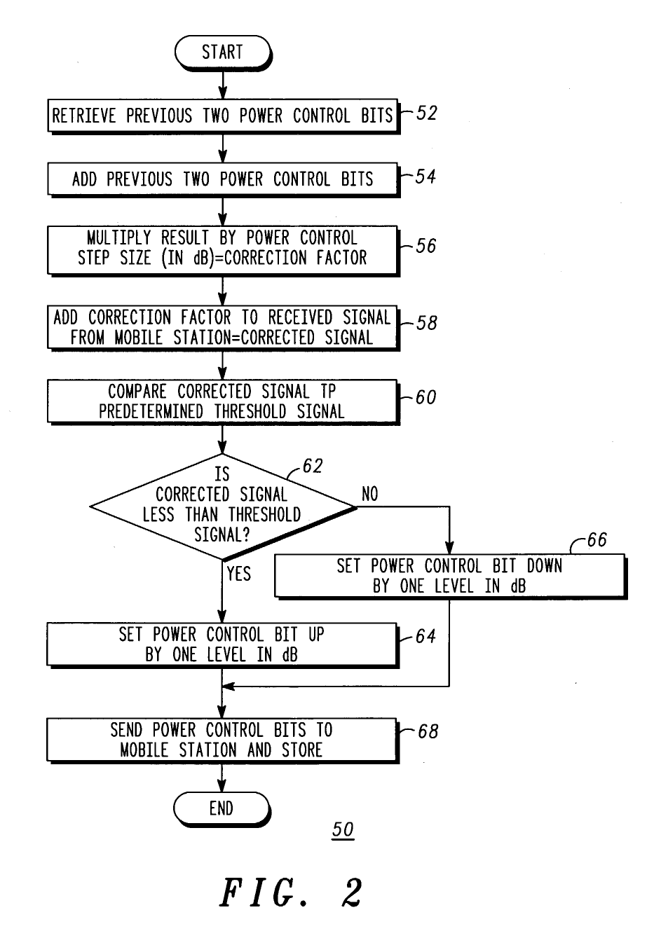

Turning now to FIG. 2, a flow chart of the power control method is shown. The method will be explained by example for the base station controlling the power used by the mobile station to transmit data to it. The power control method is begun and the start block is entered. Next, the base station retrieves the previous two power control bits (PCB), block 52. Next, block 54 adds the previous two power control bits. That is, if the last two power control bits were a +1, this indicates that the last two requests were to turn the power up one level. The power control levels and hence steps may be considerably less than −1 dB and greater than 1 dB with 1 being the nominal value.

Next, the result of the addition of the previous two power control bits is multiplied by the power control step size in dB to determine a correction factor, block 56. For example, if the last two power control bits were both +1, the result is a +2 and block 56 multiplies this result by the power control step size, nominally 1 dB. This creates a correction factor for the power control bits that are still in the pipeline. That is, the power control bits which have been previously transmitted to the mobile station but have not been acted upon yet.

Next, block 58 adds the correction factor to the power as determined from the received signal from the mobile station. This result is termed a corrected signal. Then the corrected signal is compared to a predetermined threshold signal, block 60.

If the corrected signal is less than the threshold value, block 62 transfers control to block 64 via the yes path. This corresponds to the base station having received a frame with a signal to noise ratio (Eb/No) lower than the desired target threshold. As a result, the base station sets the power control bit to show a power up. In this way, the base station tells the mobile station to turn its transmit power up by one level. Then block 68 transmits the power control bit to the mobile unit and stores the power control bit as a previous power control bit, block 68. Process 50 is then ended.

If the corrected signal was equal to or greater than the threshold signal, block 62 transfers control to block 66 via the no path. This corresponds to the base station having received a frame of data from the mobile station that has a signal to noise ratio (Eb/No) that is equal to or greater than the desired target threshold. Then base station sets the power control bit down by one level in decibels (dB), block 66. Then the base station transmits the power control bit to the mobile unit and stores it, block 68. Process 50 is then ended.

The present power control method is particularly suitable for CDMA based mobile telecommunication systems. This power control method may be applied to both the inner and outer loops in such a telecommunication system. Further, this power control method is suitable for other air interfaces such as W-CDMA, EV-DV and EV-DO.

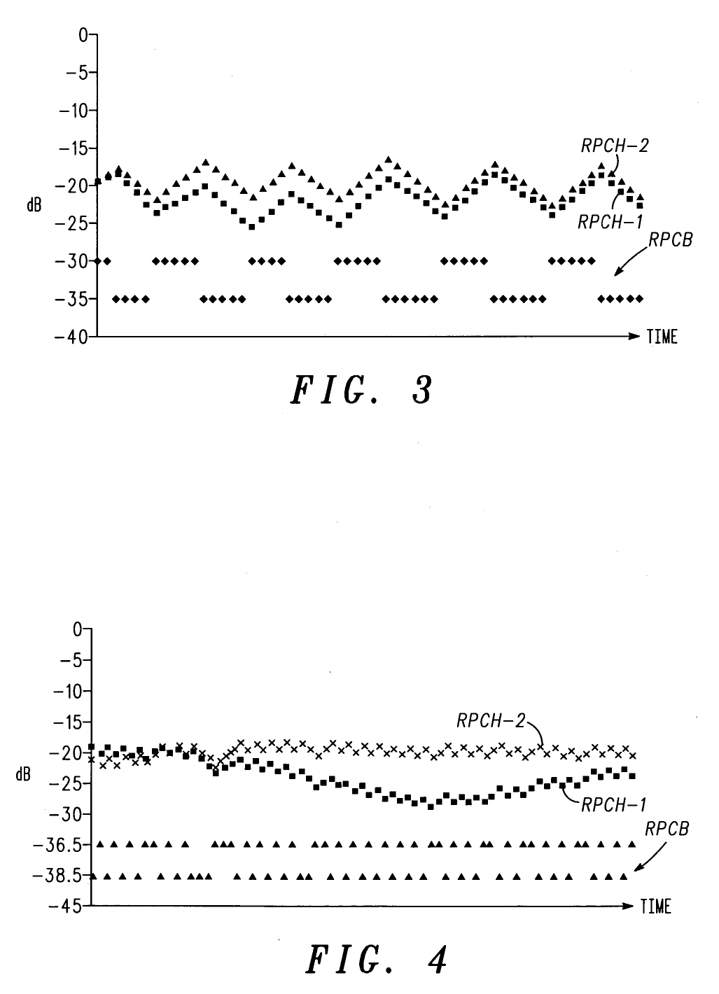

Turning now to FIG. 3, a diagram of the power control commands for two base stations, 20 and 25 for example when communicating with mobile station 1. Further, the power control bits in time are displayed. Graphs RPCH-1 and RPCH-2 correspond to the observed power by base stations 20 and 25 from a mobile unit 1. As can be seen, these transmission powers on the reverse channel first move in an upward direction for about 5 power control bits and then downward for about 5 control bits. The signals RPCH the reverse channel power control bits themselves are displayed in addition. As can be observed, there are 5 power control bits set in an upward level and then 5 power control bits set in a downward level. This corresponds to the power oscillation problem displayed by the prior art.

FIG. 4 depicts a diagram of similar power transmitted by a mobile station wherein the base station includes the present power control method 50. FIG. 4 depicts the transmitted power by the mobile unit as measured at two base stations 20 and 25, for example. RPCH-1 and RPCH-2 may correspond to base stations 25 and 20, for example. That is, RPCH-2 measures a more or less steady transmit power of mobile station 1. RPCH-1 measures a slightly declining power due to various transmission conditions such as noise, etc. RPCH-2 is the primary data communication link while since RPCH-1 has diminished power from mobile station 1 is the secondary transmission link. The resulting pattern of power control is now an ideal situation in which one power control bit is up and the next is down. As a result, the power of the data transmitted from the mobile station 1 to base station 20, for example, has about a 1 dB of movement, as opposed to the 5 dB swing shown in the prior art.

As can be appreciated from the above explanation, this power control method decreases the total transmit power in the telecommunication system. As a result, interference between mobile links is minimized and the system is able to handle more mobile stations. Further, the battery life of the mobile station is extended. This power control method 50 may be applied not only in the base station to control the reverse channel power, but also in the mobile station to control the power of the data transmitted on the forward link. Further, power control method 50 may be employed at various functions of the base station. That is, they may be employed in the RAN 22 or in the radio network controller 24.

Although the preferred embodiment of the invention has been illustrated, and that form described in detail, it will be readily apparent to those skilled in the art that various modifications may be made therein without departing from the spirit of the present invention or from the scope of the appended claims.

1. In a base station of a mobile telecommunication system, a power control method comprising the steps of:
adjusting by a mobile station a power level of a data signal in response to a plurality of power control bits (PCB) transmitted by the base station;
combining by the base station a number of previous power control bits to produce a combined PCB;
scaling by the base station the combined PCB to produce a scaled PCB; and
adjusting by the base station a next PCB in response to the scaled PCB.

2. In the base station, a power control method as claimed in claim 1, wherein the step of combining further includes the steps of:
obtaining by the base station a plurality of previous power control bits; and
adding by the base station the plurality of previous power control bits to produce the combined PCB.

3. In the base station, the power control method as claimed in claim 2, wherein there is further included a step of multiplying by the base station the combined PCB by a step size to produce the scaled PCB.

4. In the base station, the power control method as claimed in claim 3, wherein there is further included the steps of:
receiving by the base station the power level of the data signal from the mobile station; and
adding by the base station the scaled PCB to the power level to produce a corrected signal.

5. In the base station, the power control method as claimed in claim 4, wherein the step of adjusting includes a step of determining by the base station whether the corrected signal is less than a predetermined threshold signal.

6. In the base station, the power control method as claimed in claim 5, wherein if the corrected signal is less than the predetermined threshold signal, there is further included steps of:
setting by the base station the next PCB up by one for the power level;
sending by the base station the next PCB to the mobile station; and
storing by the base station the next PCB as a most recent previous PCB.

7. In the base station, the power control method as claimed in claim 5, wherein if the corrected signal is greater than or equal to the predetermined threshold signal there is further included the steps of:
setting by the base station the next PCB down by one for the power level;
sending by the base station the next PCB to the mobile station; and
storing by the base station the next PCB by the base station as a most recent previous PCB.

8. In a radio access network (RAN) of a base station of a mobile telecommunication system, a power control method comprising, the steps of:
adjusting by a mobile station a power level of a data signal in response to a plurality of power control bits (PCB) transmitted by the radio access network (RAN);
combining by the RAN a number of previous power control bits to produce a combined PCB;
scaling by the RAN the combined PCB to produce a scaled PCB; and
adjusting by the RAN a next PCB in response to the scaled PCB.

9. In the radio access network, a power control method as claimed in claim 8, wherein the step of combining further includes the steps of:
obtaining by the RAN a plurality of previous power control bits; and
adding by the RAN the plurality of previous power control bits to produce the combined PCBs.

10. In the radio access network, the power control method as claimed in claim 9, wherein there is further included the step of multiplying by the RAN the combined PCBs by a step size to produce the scaled PCB.

11. In the radio access network, the power control method as claimed in claim 10, wherein there is further included the steps of:
receiving by the RAN the power level of the data signal from the mobile station; and
adding by the RAN the scaled PCB to the power level to produce a corrected signal.

12. In the radio access network, the power control method as claimed in claim 11, wherein the step of adjusting includes a step of determining by the RAN whether the corrected signal is less than a predetermined threshold signal.

13. In the radio access network, the power control method as claimed in claim 12, wherein if the corrected signal is less than the predetermined threshold signal, there is further included steps of:
setting by the RAN the next PCB up by one for the power level;
sending by the RAN the next PCB to the mobile station; and
storing by the RAN the next PCB as a most recent previous PCB.

14. In the radio access network, the power control method as claimed in claim 12, wherein if the corrected signal is greater than or equal to the predetermined threshold signal there is further included the steps of:
setting by the RAN the next PCB down by one for the power level;
sending by the RAN the next PCB to the mobile station; and
storing by the RAN the next PCB by the base station as a most recent previous PCB.

15. In a radio network controller (RNC) of a base station of a mobile telecommunication system, a power control method comprising the steps of:
adjusting by a mobile station a power level of a data signal in response to a plurality of power control bits (PCB) transmitted by the radio network controller;
combining by the radio network controller a number of previous power control bits to produce a combined power control bit;
scaling by the radio network controller the combined power control bit to produce a scaled power control bit; and
adjusting by the radio network controller a next power control bit in response to the scaled power control bit.

16. In the radio network controller, a power control method as claimed in claim 15, wherein the step of combining further includes the steps of:
obtaining by the radio network controller a plurality of previous power control bits; and
adding by the radio network controller the plurality of previous power control bits to produce the combined PCB.

17. In the radio network controller, the power control method as claimed in claim 16, wherein there is further included a step of multiplying by the radio network controller the combined PCB by a step size to produce the scaled PCB.

18. In the radio network controller, the power control method as claimed in claim 17, wherein there is further included the steps of:
receiving by the radio network controller the power level of the data signal from the mobile station; and
adding by the radio network controller the scaled PCB to the power level to produce a corrected signal.

19. In the radio network controller, the power control method as claimed in claim 18, wherein the step of adjusting includes a step of determining by the radio network controller whether the corrected signal is less than a predetermined threshold signal.

20. In the radio network controller, the power control method as claimed in claim 19, wherein if the corrected signal is less than the predetermined threshold signal, there is further included steps of:
setting by the radio network controller the next PCB up by one for the power level;
sending by the radio network controller the next PCB to the mobile station; and
storing by the radio network controller the next PCB as a most recent previous PCB.

21. In the radio network controller, the power control method as claimed in claim 19, wherein if the corrected signal is greater than or equal to the predetermined threshold signal there is further included the steps of:
setting by the radio network controller the next PCB down by one for the power level;
sending by the radio network controller the next PCB to the mobile station; and
storing by the radio network controller the next PCB by the base station as a most recent previous PCB.

22. In a mobile station of a mobile telecommunication system, a power control method comprising the steps of:
adjusting by a base station a power level of a data signal in response to a plurality of power control bits (PCB) transmitted by the mobile station;
combining by the mobile station a number of previous power control bits (PCB) to produce a combined PCB;
scaling by the mobile station the combined PCB to produce a scaled PCB; and
adjusting by the mobile station a next PCB in response to the scaled PCB.

23. In the mobile station, a power control method as claimed in claim 22, wherein the step of combining further includes the steps of:
obtaining by the mobile station a plurality of previous power control bits; and
adding by the mobile station the plurality of previous power control bits to produce the combined PCB.

24. In the mobile station, the power control method as claimed in claim 23, wherein there is further included a step of multiplying by the mobile station the combined PCB by a step size to produce the scaled PCB.

25. In the mobile station, the power control method as claimed in claim 24, wherein there is further included the steps of:
receiving by the mobile station the power level of the data signal from the base station; and
adding by the mobile station the scaled PCB to the power level to produce a corrected signal.

26. In the mobile station, the power control method as claimed in claim 25, wherein the step of adjusting includes a step of determining by the mobile station whether the corrected signal is less than a predetermined threshold signal.

27. In the mobile station, the power control method as claimed in claim 26, wherein if the corrected signal is less than the predetermined threshold signal, there is further included steps of:
setting by the mobile station the next PCB up by one for the power level;
sending by the mobile station the next PCB to the mobile station; and
storing by the mobile station the next PCB as a most recent previous PCB.

28. In the mobile station, the power control method as claimed in claim 26, wherein if the corrected signal is greater than or equal to the predetermined threshold signal there is further included the steps of:
setting by the mobile station the next PCB down by one for the power level;
sending by the mobile station the next PCB to the mobile station; and
storing by the mobile station the next PCB by the base station as a most recent previous PCB.
